(19) United States
(12) Patent Application Publication
(10) Pub. No.: US 2005/0146815 A1
(43) Pub. Date: Jul. 7, 2005

(54) Electrical, transmission/substation/distribution shunt capacitor switching and control system with integrated, automatically resettable, overcurrent protection

(76) Inventors: David L. Donovan, Foxboro, MA (US); Robert E. Joyce, Shaker Heights, OH (US); Lance P. Sabados, North Ridgeville, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/010,646

(22) Filed: Dec. 13, 2004

Related U.S. Application Data
(60) Provisional application No. 60/528,852, filed on Dec. 11, 2003.

(51) Int. Cl. H02H 7/16

(52) U.S. Cl. 361/15

(57) ABSTRACT

A capacitor switch and control system for high-power transmission/distribution lines comprising a branch circuit comprising a capacitor, a capacitor switch, a capacitor control, and a sensor, where the capacitor control is operative to control the opening of the capacitor switch upon the sensor sensing at least one of an overload condition and a fault condition, and control the closing of the capacitor switch. The invention also includes a method for protecting transmission/distribution line capacitors from faults comprising: (a) monitoring a capacitor branch of a transmission line for a fault condition; and (b) responding to the fault condition by automatically opening a switch on the capacitor branch to provide an open circuit between the transmission line and a branch capacitor, where the switch is repositionable between an open position and a closed position.

### CROSS REFERENCE TO RELATED APPLICATIONS

This application claims the benefit of U.S. Provisional Patent Application Ser. No. 60/528,852, filed Dec. 11, 2003, and entitled “ELECTRICAL, TRANSMISSION/SUBSTATION/DISTRIBUTION SHUNT CAPACITOR SWITCHING AND CONTROL SYSTEM WITH INTEGRATED, AUTOMATICALLY RESETTABLE, OVERCURRENT PROTECTION,” the disclosure of which is incorporated herein by reference.

### BACKGROUND

1. Field of the Invention

The present invention relates generally to shunt capacitor branch circuits and switch systems for high-power transmission/distribution lines, and more particularly to automatically reclosable capacitor switches located within the capacitor switch system.

2. Background of the Invention

In order to increase the efficiency of high-power transmission/distribution lines during certain times of the day, capacitor switch systems were developed and coupled to the high-power transmission/distribution lines. The most common prior art capacitor switch systems include a fuse in series with the capacitor bank to break the circuit on the capacitor branch in response to overload or fault conditions. Essentially, the fuse protects the transmission/distribution line and the shunt capacitor in the event of a large current surge condition. Examples of events causing surge conditions includes instances when an impediment, such as a tree branch, gets caught in the transmission/distribution wires, a capacitor bank fails, or a transient power surges appear on the transmission/distribution line.

A disadvantage associated with the prior art fuse systems is that when the fuse is blown, the power company may not learn of the blown condition prior to a manual inspection. Such manual inspections may occur many months after the fuse is blown. In other words, a manual on-site inspection of the fuse is the most reliable way to learn if a fuse has blown.

More recent developments in electrical transmission technology have included the addition of fault indicators that utilizes a mechanical flag or an indicator light to alert repair personnel of a faulted condition during a manual inspection. Nevertheless, these fault indicators rely on visual perception that would essentially require personnel to continuously watch each fault indicator to discern in real-time whether a fuse had blown.

### SUMMARY OF THE INVENTION

The present invention is directed to capacitor systems and transmission/distribution networks using the same, where the capacitor bank system (shunt connection, fuse, capacitor bank, control, and switch) increases the efficiency of high-powered transmission/distribution lines. The capacitor switching and control system of the present invention includes recloser logic built into a capacitor control that opens a capacitor switch upon input from a current sensor in the capacitor switch assembly, sensing overload or fault conditions. The capacitor switch recloses the capacitor branch circuit after a predetermined period of time and remains closed as long as overload or fault conditions are not detected.

The present invention replaces or protects the fuse of the prior art with a reclosable switching and capacitor control system having protection logic that opens the switch when a current sensor associated with the capacitor switch assembly detects a current overload or fault condition. The capacitor control logic emulates the function of the fuse, but has the advantage that the capacitor control logic can additionally reclose the switch and later retest for a current fault. If no fault exists (i.e., the fault was temporary), the capacitor switch remains closed. If the fault is still present in the capacitor branch, however, the capacitor switch is opened once again and the sequence of closing and retesting may be repeated at a later time. Accordingly, an advantage of the present invention includes allowing the capacitor branch circuit to automatically recover from temporary overload conditions.

### BRIEF DESCRIPTION OF THE DRAWINGS

FIG. 1 is a partial perspective view of the prior art showing transmission/distribution lines operatively coupled with shunt capacitor switch systems;

FIG. 2 is a schematic diagram of the prior art; and

FIG. 3 is a schematic diagram of an exemplary embodiment of the present invention.

### DETAILED DESCRIPTION

It should be understood that the following detailed description of exemplary embodiments of the present invention are exemplary in nature and are not intended to constitute limitations upon the present invention. It is also to be understood that variations of the exemplary embodiments contemplated by one of ordinary skill in the art shall concurrently fall within the scope and spirit of the invention. Although certain aspects of the exemplary embodiments are shown in more detail, some features within the purview of one skilled in the art may have been omitted for the sake of clarity and brevity.

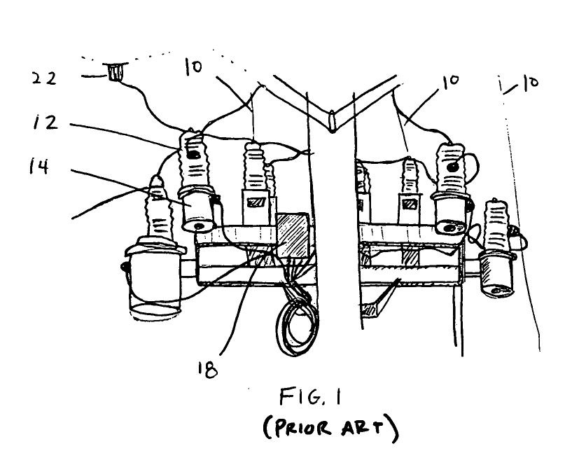

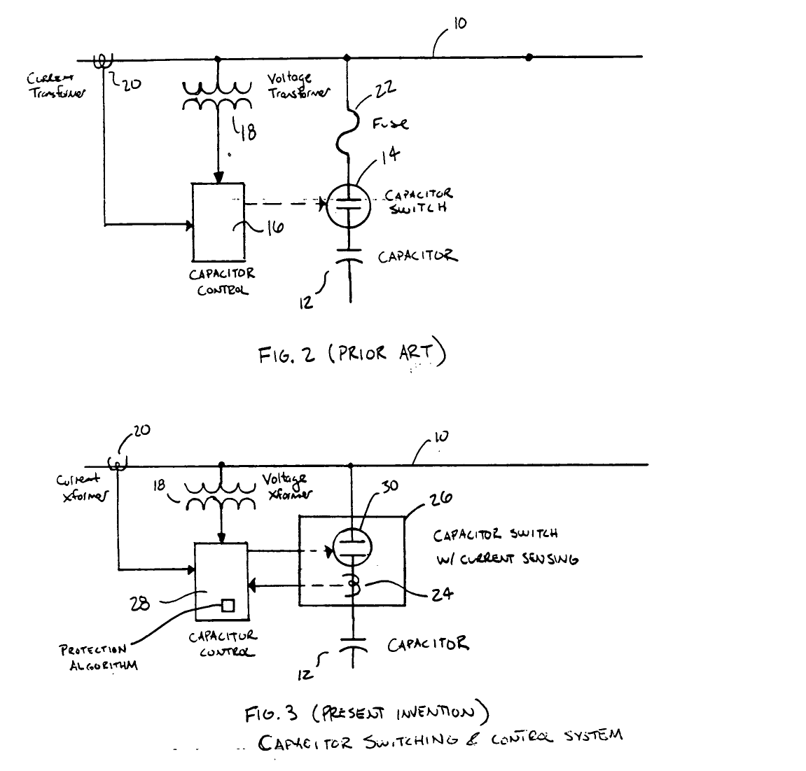

Referencing FIGS. 1 and 2, a capacitor switching system 8 includes a high-power transmission/distribution line 10 and a shunt capacitor 12 coupled thereto for increasing the efficiency of the transmission/distribution during certain periods of the day. The capacitor switching system 8 also includes a capacitor switch 14 coupled in series therewith, which is operatively coupled to a capacitor control box 16. The capacitor control box 16 monitors the voltage on the transmission/distribution line 10 via a voltage transformer 18, monitors the current on the transmission/distribution line 10 via a current transformer 20, and switches the capacitor switch 14 open and close depending upon the sensed loads and calculated Vars on the transmission/distribution line 10. Additionally, the capacitor control box 16 may switch the capacitor switch 14 open and close based on time, temp, etc. The capacitor switching system 8 further includes a fuse 22 coupled in series between the capacitor 12 and the transmission/distribution line 10 to break the circuit leading to the capacitor 12 in certain overload conditions (such as when a tree branch gets caught up in the wires).

A limitation of this prior art embodiment 8 requires the fuse 22 to be manually reset or replaced subsequent to a blown condition. Thus, the fuse 22 of the capacitor switching system 8 can be blown for a significant period of time before repair personnel either know of or are able to fix the problem.

Referring to FIG. 3, the present invention 23 replaces (or supplements) the fuse 22 (See FIG. 2) of the prior art with a current sensor 24 built into a capacitor switch assembly 26, where a capacitor control 28 monitors the load reading of the current sensor 24 and opens a capacitor switch 30 in the capacitor switch assembly 26 when load readings from the current sensor 24 are representative of an overload condition. Control logic 31 is built into the capacitor control 28 to emulate the function of the fuse.

Approximately 95% of all current faults are temporary and, therefore, the capacitor control 28 is operative to close the capacitor switch 30 at a later time (i.e., hours or days in the future) and monitor the load reading from the current sensor 24. If the overload condition still exists, the capacitor control logic 31 will direct that the switch 30 be opened again. In sum, the control logic 31 built into the capacitor control 28 allows the capacitor branch circuit to be reclosed when the faults are removed.

Following from the above description and invention summaries, it should be apparent to those of ordinary skill in the art that, while the methods and apparatuses herein described constitute exemplary embodiments of the present invention, the invention contained herein is not limited to these precise embodiments and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

1. A capacitor switch and control system for high-power transmission/distribution lines comprising:
a branch circuit comprising a capacitor, a capacitor switch, a capacitor control, and a sensor, where the capacitor control is operative to control the opening of the capacitor switch upon the sensor sensing at least one of an overload condition and a fault condition, and control the closing of the capacitor switch.

2. The capacitor switch and control system of claim 1, wherein:
the capacitor control is operative to control the closing of the capacitor switch in the absence of at least one of the overload condition and the fault condition subsequent to the opening of the capacitor switch.

3. The capacitor switch and control system of claim 1, wherein:
the capacitor control is operative to control the closing of the capacitor switch upon the sensor not sensing at least one of the overload condition and the fault condition.

4. The capacitor switch and control system of claim 1, wherein:
the capacitor control is operative to control a cycling of the capacitor switch between an open position and a closed position; and
the capacitor control is operative to control the closing of the capacitor switch after a predetermined period of time from when the sensor sensed at least one of the overload condition and the fault condition.

5. The capacitor switch and control system of claim 4, wherein:
the sensor includes a current sensor; and
the output of the current sensor is in communication with the capacitor control to influence the cycling of the capacitor switch.

6. A capacitor switch and control system for high-power transmission/distribution lines comprising:
a controller operatively coupled to a switch in communication between a branch capacitor and an electrical transmission line, the controller automatically operative to at least one of close and open the switch in response to at least one of an overload condition and a fault condition.

7. The capacitor switch and control system of claim 6, wherein:
the switch is associated with a capacitor branch of a transmission network;
the controller monitors a load, using a current sensor, on the capacitor branch and automatically opens the switch on the capacitor branch in response to detecting the overload condition.

8. The capacitor switch and control system of claim 6, wherein:
the controller includes logic circuitry operative to control opening the switch in response to at least one of the overload condition and the fault condition;
the logic circuitry is communicatively coupled to a sensor operative to detect at least one of the overload condition and the fault condition; and
the logic circuitry operative to open the switch when at least one of:
the sensor no longer detects at least one of the overload condition and the fault condition, and
a predetermined period of time has elapsed subsequent to the opening of the switch.

9. A method for protecting transmission/distribution line capacitors from faults comprising:
monitoring a capacitor branch of a transmission line for a fault condition; and
responding to the fault condition by automatically opening a switch on the capacitor branch to provide an open circuit between the transmission line and a branch capacitor, where the switch is repositionable between an open position and a closed position.

10. The method of claim 9, further comprising:
responding to an absence of the fault condition by automatically closing the switch in order to provide communication between the transmission line and the branch capacitor.

11. The method of claim 10, wherein:
the act of monitoring the capacitor branch of the transmission line for the fault condition includes testing the capacitor branch for the fault condition; and
the act of testing the capacitor branch for the fault condition includes automatically closing the switch.

12. A capacitor switch and control system for high-power transmission/distribution lines comprising a capacitor controller adapted to be in electrical communication with a transmission line and operative to selectively control, using a logic circuit, at least one of opening and closing of a capacitor switch.

13. The capacitor switch and control system of claim 12, wherein:
the logic circuit is operative to control the opening of the capacitor switch in response to a fault condition; and
the logic circuit is operative to control the closing of the capacitor switch in an absence of the fault condition.

14. The capacitor switch and control system of claim 12, wherein the logic circuit is operative to control the closing of the capacitor switch in response to not immediately following the absence of the fault condition.

15. The capacitor switch and control system of claim 12, wherein:
the logic circuit is operative to control the opening of the capacitor switch in response to a fault condition; and
the logic circuit is operative to control the closing of the capacitor switch after a predetermined period of time from when the capacitor switch was opened.
